(19) United States
(12) Patent Application Publication
(10) Pub. No.: US 2026/0152584 A1
(43) Pub. Date: Jun. 4, 2026

(54) COMPOUNDING COMPOSITION COMPRISING RECYCLED POLYPROPYLENE RESIN

(71) Applicants: Hyundai Motor Company, Seoul (KR); Kia Corporation, Seoul (KR); KOLON ENP, Inc., Gimcheon-si (KR)

(72) Inventors: Min Gyun Chung, Hwaseong-si (KR); Hyeongwon Park, Hwaseong-si (KR); Hansol Ji, Gimcheon-si (KR)

(73) Assignees: Hyundai Motor Company, Seoul (KR); Kia Corporation, Seoul (KR); KOLON ENP, INC., Gimcheon-si (KR)

(21) Appl. No.: 19/059,702

(22) Filed: Feb. 21, 2025

(30) Foreign Application Priority Data
Nov. 29, 2024 (KR) 10-2024-0175261

(51) Int. Cl. C08F 10/06

(52) U.S. Cl. CPC C08F 10/06

(57) ABSTRACT

The present disclosure relates to a compounding composition comprising a recycled polypropylene resin. The compounding composition including the recycled polypropylene resin of the present disclosure may improve the appearance quality of an injection-molded product without causing a phenomenon of aggregating glass fibers because the flowability is not reduced during injection. In addition, the compounding composition including the recycled polypropylene resin of the present disclosure may exhibit excellent mechanical properties despite a high content of the recycled polypropylene resin.

### CROSS-REFERENCE TO RELATED APPLICATION

This present application claims the benefit of priority to Korean Patent Application No. 10-2024-0175261, entitled “COMPOUNDING COMPOSITION COMPRISING RECYCLED POLYPROPYLENE RESIN,” filed on Nov. 29, 2024, in the Korean Intellectual Property Office, the entire disclosure of which is incorporated herein by reference.

### FIELD

The present disclosure relates to a compounding composition including a recycled polypropylene resin.

### BACKGROUND

Polypropylene resins are versatile materials known for their exceptional chemical resistance, weather resistance, ease of processing, and lightweight characteristics, which facilitate their manufacture into various forms, including injection-molded products, films, and blow-molded items. These properties have led to their widespread application across multiple industries, such as electrical components, automotive manufacturing, and building materials. Recently, with intensified research aimed at reducing the weight of hydrogen fuel cell vehicles and enhancing fuel efficiency, there has been a notable shift towards substituting traditional metal components in automobiles with polypropylene resins, thereby optimizing performance and sustainability in vehicle design.

In light of growing environmental concerns, particularly regarding carbon dioxide (CO2) emissions, there is an increasing demand for the development of recycled plastics that can effectively regenerate and utilize post-consumer polypropylene resins. This shift towards recycling not only addresses sustainability challenges but also promotes a circular economy by minimizing waste and conserving resources, thereby contributing to the reduction of the overall carbon footprint associated with plastic production and disposal.

However, recycled polypropylene resin undergoes oxidation after prolonged use in everyday applications and is subjected to additional thermal stress during reprocessing, which can result in a decline in its mechanical properties, heat resistance, and dimensional stability compared to virgin polypropylene resin. To mitigate these disadvantages and enhance the performance of recycled materials, a common practice involves blending virgin polypropylene resin with recycled polypropylene resin, thereby improving the overall quality and functionality of the resulting recycled plastics.

In the case of composite materials that incorporate a blend of polypropylene resin and glass fiber, a significant challenge arises from the differing flow properties of virgin polypropylene resin and recycled polypropylene resin. This mismatch in flowability can lead to difficulties in achieving a uniform distribution of glass fibers within the matrix, resulting in the aggregation of fibers on the surface during the injection molding process. Consequently, the content of recycled polypropylene resin may be constrained, as excessive amounts can exacerbate these flow issues and negatively impact the overall performance and mechanical properties of the composite material.

To address these challenges, the present disclosure introduces a compounding composition that effectively combines virgin and recycled polypropylene resins with an optimized melt flow index. This innovative formulation enhances flowability and ensures consistent mechanical properties, even when incorporating a high percentage of recycled content. By carefully balancing the characteristics of both resin types, this composition not only improves processing efficiency but also maintains the integrity and performance of the final product.

### SUMMARY

According to an aspect of the present disclosure, there is provided a compounding composition including a recycled polypropylene resin having excellent injection appearance quality.

In embodiments, disclosed herein is a compounding composition including a recycled polypropylene resin having excellent mechanical properties during injection even if the content of the recycled polypropylene resin is high.

In embodiments, disclosed herein is a compounding composition including a recycled polypropylene resin that may be applied to green technology fields, such as the manufacture of a stack vent filter cover for a hydrogen fuel cell vehicle.

In embodiments, disclosed herein is a compounding composition including a polypropylene resin including a virgin polypropylene resin having a melt-flow index of 60 g/10 min to 100 g/10 min and a recycled polypropylene resin having a melt-flow index of 80 g/10 min to 100 g/10 min, as measured under conditions of 230° C. and 2.16 kg load according to ASTM D1238; glass fiber; and an additive.

According to an example of the present disclosure, the polypropylene resin may comprise the virgin polypropylene resin and the recycled polypropylene resin in a weight ratio of 1:0.1 to 1:3.

According to an example of the present disclosure, the virgin polypropylene resin may comprise a homopolypropylene resin, an ethylene-propylene copolymer resin, or a combination thereof.

According to an example of the present disclosure, the recycled polypropylene resin may comprise a homopolypropylene resin, an ethylene-propylene copolymer resin, an ethylene-octene copolymer resin, or a combination thereof.

According to an example of the present disclosure, the glass fiber may have a cross-sectional diameter of 12 μm to 20 μm and an average length of 6 mm to 20 mm.

According to an example of the present disclosure, the glass fiber may be surface-modified by a silane coupling agent.

According to an example of the present disclosure, the additive may comprise at least one selected from the group consisting of a compatibilizer, an impact-resistant agent, a heat-resistant agent, a colorant, a release agent, and a nucleating agent.

According to an example of the present disclosure, the compounding composition may comprise 50 wt % to 60 wt % of the polypropylene resin, 20 wt % to 50 wt % of the glass fiber, and 5 wt % to 20 wt % of the additive, based on the total weight of the compounding composition.

According to an example of the present disclosure, the compounding composition may have an Izod impact strength of 10 kJ/m² to 50 kJ/m² as measured according to ISO 180.

According to an example of the present disclosure, the compounding composition may have a heat deflection temperature of 150° C. to 200° C. as measured according to ISO 75.

In another aspect of the present disclosure, there is provided an injection-molded product formed from the compounding composition.

According to an example of the present disclosure, the compounding composition including the recycled polypropylene resin can improve the appearance quality of an injection-molded product without causing a phenomenon of aggregating glass fibers because the flowability is not reduced during injection.

According to an example of the present disclosure, the compounding composition including the recycled polypropylene resin can exhibit excellent mechanical properties despite a high content of the recycled polypropylene resin.

### BRIEF DESCRIPTION OF THE DRAWINGS

FIG. 1 is a photograph evaluating the appearance of injection-molded products manufactured with compounding compositions according to (a) Example 1, (b) Example 2, and (c) Example 3 of the present disclosure.

FIG. 2 is a photograph evaluating the appearance of injection-molded products manufactured with compounding compositions according to (a) Comparative Example 2 and (b) Comparative Example 6.

### DETAILED DESCRIPTION

Hereinafter, the present disclosure will be described in more detail. However, the following examples or embodiments are only a reference for explaining the present disclosure in detail, and the present disclosure is not limited thereto, and may be implemented in various forms.

Further, unless otherwise defined, all technical and scientific terms have the same meaning as commonly understood by those skilled in the art to which the present disclosure pertains.

The terminology used in the description in the present disclosure is merely to effectively describe specific examples and is not intended to limit the present disclosure.

In addition, as used in the specification and the appended claims, the singular forms may be intended to comprise plural forms, unless clearly dictated in the contexts otherwise.

In addition, units used in this specification without special mention are based on weight, and for example, units of % or ratio mean wt % or weight ratio, and wt % means wt % of any one component in the entire composition, unless otherwise defined.

Further, unless explicitly described to the contrary, when any part “comprises” any component, it will be understood to further comprise another component rather than excluding another component.

In addition, the numerical ranges used in the present disclosure may comprise lower and upper limits and all values within that range, increments logically derived from the shape and width of the defined range, all doubly defined values, and all possible combinations of upper and lower limits of numerical ranges defined in different shapes. Unless otherwise specifically defined in the specification of the present disclosure, values out of the numerical range that may arise due to experimental error or rounding of values are also comprised in the defined numerical range.

Hereinafter, the present disclosure will be described in more detail.

The present disclosure relates to a compounding composition including a polypropylene resin including a virgin polypropylene resin and a recycled polypropylene resin, glass fiber, and an additive. The compounding composition of the present disclosure may exhibit excellent injection appearance quality by organically combining the virgin polypropylene resin and the recycled polypropylene resin satisfying a melt-flow index in a limited range with the glass fiber, and the mechanical properties are not deteriorated even if the content of the recycled polypropylene resin is high.

The present disclosure provides a compounding composition including a polypropylene resin including a virgin polypropylene resin and a recycled polypropylene resin; glass fiber; and an additive.

In an example of the present disclosure, the virgin polypropylene resin may have a melt-flow index measured under conditions of 230° C. and 2.16 kg load according to ASTM D1238 in a lower limit of 60 g/10 min or more, 65 g/10 min or more, 70 g/10 min or more, 75 g/10 min or more, or 80 g/10 min or more, and an upper limit of 100 g/10 min or less, 95 g/10 min or less, or 90 g/10 min or less. When the range is satisfied, the virgin polypropylene resin itself has excellent thermal and mechanical properties, and has a good impregnation property with long-fiber glass fibers, thereby securing excellent physical properties of the compounding composition.

In an example of the present disclosure, the recycled polypropylene resin may have a melt-flow index measured under conditions of 230° C. and 2.16 kg load according to ASTM D1238 in a lower limit of 80 g/10 min or more, 82 g/10 min or more, 85 g/10 min or more, or 87 g/10 min or more, and an upper limit of 100 g/10 min or less, 95 g/10 min or less, or 90 g/10 min or less. When the range is satisfied, it is possible to suppress damage to glass fibers caused by the characteristics of the recycled polypropylene resin, which inevitably comprises impurities, prevent the appearance quality from being deteriorated due to glass fiber aggregation, and secure excellent heat resistance and mechanical properties.

In an example of the present disclosure, the compounding composition may comprise the virgin polypropylene resin and the recycled polypropylene resin in a weight ratio of 1:0.5 to 1:5, specifically a weight ratio of 1:1 to 1:3. When the range is satisfied, it is possible to maximize the content of the recycled polypropylene resin and satisfy excellent mechanical properties of an injection-molded product using the compounding composition.

According to an example of the present disclosure, the virgin polypropylene resin may comprise a homopolypropylene resin, an ethylene-propylene copolymer resin, or a combination thereof.

According to an example of the present disclosure, the recycled polypropylene resin may comprise a homopolypropylene resin, an ethylene-propylene copolymer resin, an ethylene-octene copolymer resin, or a combination thereof.

According to an example of the present disclosure, the glass fiber may have a cross-sectional diameter of 12 μm to 20 μm, specifically 15 μm to 20 μm, and an average length of 6 mm to 20 mm, specifically 9 mm to 11 mm. When the range is satisfied, the mechanical properties of the compounding composition are excellent.

According to an example of the present disclosure, the glass fiber may be surface-modified by a silane coupling agent. Through surface modification, the interfacial adhesion between the glass fiber and the polypropylene resin may be improved, thereby ensuring excellent mechanical properties and heat resistance of the compounding composition.

In an example of the present disclosure, the silane coupling agent may be a silane coupling agent having an organic functional group such as aminosilane and glycidyl silane, but is not limited thereto as long as the purpose of the present disclosure may be achieved.

According to an example of the present disclosure, the additive may comprise at least one selected from the group consisting of a compatibilizer, an impact-resistant agent, a heat-resistant agent, a colorant, a release agent, and a nucleating agent.

According to an example of the present disclosure, the compatibilizer may be a homopolypropylene grafted with maleic anhydride, an ethylene-propylene copolymer, an ethylene-octene copolymer, or a combination thereof.

In an example of the present disclosure, the compatibilizer may be comprised in an amount of 1.0 wt % to 5.0 wt %, specifically 2.0 wt % to 4.0 wt %, and more specifically 2.5 wt % to 3.0 wt %, based on the total weight of the compounding composition. When the range is satisfied, the compatibility between the polypropylene resin and the glass fiber may be improved, thereby improving the mechanical properties of the compounding composition.

In an example of the present disclosure, the impact-resistant agent may be used without limitation as long as it is known in the art.

In an example of the present disclosure, the impact-resistant agent may be comprised in an amount of 0.5 wt % to 3.0 wt %, specifically 1.0 wt % to 2.5 wt %, and more specifically 1.5 wt % to 2.0 wt %, based on the total weight of the compounding composition. When the range is satisfied, the impact-resistant agent may be evenly dispersed in the composition without reducing the mechanical properties of the compounding composition, thereby effectively improving the impact performance.

In an example of the present disclosure, the heat-resistant agent may comprise a phenol-based heat-resistant agent, a phosphorus-based heat-resistant agent, or a combination thereof.

In an example of the present disclosure, the heat-resistant agent may be comprised in an amount of 0.1 wt % to 2.0 wt %, specifically 0.5 wt % to 1.5 wt %, and more specifically 0.8 wt % to 1.0 wt %, based on the total weight of the compounding composition. When the range is satisfied, it is possible to effectively improve the heat resistance of the compounding composition.

In an example of the present disclosure, the colorant may be used without limitation as long as it is known in the art.

In an example of the present disclosure, the colorant may be comprised in an amount of 0.5 wt % to 2.0 wt %, specifically 1.0 wt % to 1.5 wt %, based on the total weight of the compounding composition, but is not limited thereto as long as the purpose of the present disclosure may be achieved.

In an example of the present disclosure, the compounding composition may comprise 50 wt % to 60 wt %, specifically 53 wt % to 55 wt % of the polypropylene resin, based on the total weight of the compounding composition. When the range is satisfied, the flowability of the compounding composition is excellent, so that the appearance quality of the injection-molded product is excellent and excellent mechanical properties may be secured.

In an example of the present disclosure, the compounding composition may comprise 20 wt % to 50 wt %, specifically 35 wt % to 45 wt % of the glass fiber, based on the total weight of the compounding composition. When the range is satisfied, the tensile strength and flexural strength of the compounding composition are not reduced, and it is possible to prevent a phenomenon of reduced injection properties due to surface defects and reduced flowability in the molding.

In an example of the present disclosure, the compounding composition may comprise 5 wt % to 20 wt % of the additive, based on the total weight of the compounding composition, but is not limited thereto as long as the purpose of the present disclosure may be achieved.

In an example of the present disclosure, the compounding composition may have an Izod impact strength measured according to ISO 180 in a lower limit of 10 kJ/m² or more, 11 kJ/m² or more, 12 kJ/m² or more, 13 kJ/m² or more, 14 kJ/m² or more, 15 kJ/m² or more, and an upper limit of non-restrictively 50 kJ/m² or less.

In an example of the present disclosure, the compounding composition may have a heat deflection temperature measured according to ISO 75 in a lower limit of 150° C. or more, 152° C. or more, 153° C. or more, or 155° C. or more, and an upper limit of non-restrictively 200° C. or less.

In an example of the present disclosure, the compounding composition may be prepared by melt-mixing the polypropylene resin, the glass fiber, and the additive.

In an example of the present disclosure, the melt-mixing may be performed at a temperature of 230° C. to 300° C., specifically 250° C. to 270° C. When the range is satisfied, it is possible to suppress the thermal decomposition or volatilization of the additive or the polypropylene resin comprised in the compounding composition and to exhibit sufficient impregnation properties of the polypropylene resin. In addition, the melt-mixing method and device are not limited as long as they are commonly used in the art.

In addition, the present disclosure provides an injection-molded product formed from the compounding composition. The injection method for forming the injection-molded product is well known to those skilled in the art to which the present disclosure pertains.

In an example of the present disclosure, the injection-molded product may be used as an engineering component of a hydrogen fuel cell vehicle, and specifically, may be used as a stack vent filter cover, but is not limited thereto.

Hereinafter, preferable Examples of the present disclosure and Comparative Examples will be described. However, the following Examples are merely a preferred example of the present disclosure, and the present disclosure is not limited to the following Examples.

### EXAMPLES

Hereinafter, the specifications of each component commonly used in Examples and Comparative Examples were as follows.

(A) A virgin polypropylene resin (Manufacturer: Polymirae Co., Ltd., Product name: HP480S, Melt-flow index: 80 g/10 min) was used.

### (B) Glass Fiber

Glass fiber (Manufacturer: Owens Corning Co., Ltd., Product name: SE4121, Cross-sectional diameter: 15 to 20 μm, length: 4 mm) was used.

### (C) Compatibilizer

Maleic anhydride modified polypropylene (Manufacturer: Woosung Chemical Co., Ltd., Product name: NB1620, Maleic anhydride graft ratio: 1.0 wt %) was used.

### (D) Impact-Resistant Agent

Polyolefin elastomer (Manufacturer: Dow Chemical Co., Ltd., Product name: Engage 8200) was used.

### (E) Heat-Resistant Agent

A heat-resistant agent (Manufacturer: Woosung Chemical Co., Ltd., Product name: NB 1020) was used.

### (F) Colorant

A Colorant (Manufacturer: Doonam Chemical Co., Ltd., Product name: MPP0406) was used.

### Example 1

Based on the total weight of a composition, 20 wt % of a recycled polypropylene resin (Manufacturer: Greenpole Co., Ltd., Product name: HB100GP, Melt-flow index: 90 g/10 min), 33.4 wt % of a virgin polypropylene resin, 2.7 wt % of a compatibilizer, 1.8 wt % of an impact-resistant agent, 0.9 wt % of a heat-resistant agent, and 1.2 wt % of a colorant were mixed using a twin-screw mixer TEX-44 with a diameter of 44 mm, and 40 wt % of glass fiber provided from Roving was impregnated therein to manufacture long-fiber reinforced resin pellets having a length of 10 mm.

### Examples 2 and 3

Pellets were manufactured in the same manner as in Example 1, except that the recycled polypropylene resin and the virgin polypropylene resin were added in the contents described in Table 1 below.

### Comparative Example 1

Pellets were manufactured in the same manner as in Example 1, except that the melt-flow index of the recycled polypropylene resin was 10 g/10 min.

### Comparative Example 2

Pellets were manufactured in the same manner as in Example 2, except that the melt-flow index of the recycled polypropylene resin was 10 g/10 min.

### Comparative Example 3

Pellets were manufactured in the same manner as in Example 1, except that the melt-flow index of the recycled polypropylene resin was 20 g/10 min.

### Comparative Example 4

Pellets were manufactured in the same manner as in Example 2, except that the melt-flow index of the recycled polypropylene resin was 20 g/10 min.

### Comparative Example 5

Pellets were manufactured in the same manner as in Example 2, except that different types of recycled polypropylene resins were mixed to have the melt-flow index of 50 g/10 min.

### Comparative Example 6

Pellets were manufactured in the same manner as in Example 1, except that the recycled polypropylene resin was not added and only 53.4 wt % of the virgin polypropylene resin was added.

The contents of each component added in Examples and Comparative Examples were shown in Table 1 below.

### Method for Measuring Physical Properties

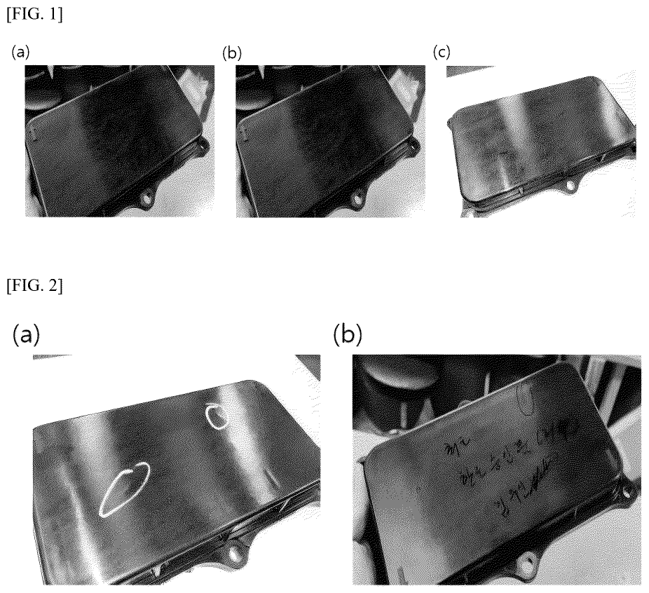

The physical properties of specimens prepared by injecting the compounding compositions of Examples and Comparative Examples were evaluated using the following method for measuring physical properties, and the results were shown in Table 1, and FIGS. 1 and 2.

(1) Tensile strength (unit: MPa): The tensile strength of a 4.0 mm-thick specimen was measured under a condition of 100 mm/min, according to ISO 527.

(2) Flexural strength (unit: MPa): The flexural strength of a 4.0 mm-thick specimen was measured under a condition of 5.8 mm/min, according to ISO 178.

(3) Notched Izod impact strength (unit: kJ/m²): The notched Izod impact strength of a 4.0 mm-thick specimen was measured according to ISO 180.

(4) Heat deflection temperature (unit: ° C.): The heat deflection temperature (HDT) was measured under conditions of a load of 1.80 MPa and a heating rate of 2° C./min according to ISO 75.

(5) Appearance evaluation: The number of fiber aggregations with a length of 0.3 cm or longer shown to the naked eye was identified on the surface of an injection-molded specimen with 400 mm×250 mm×2 mm.

TABLE 1

| | | Example | | | Comparative Example | | | | | |
|---|---|---|---|---|---|---|---|---|---|---|
| | | 1 | 2 | 3 | 1 | 2 | 3 | 4 | 5 | 6 |
| Virgin pp (wt %) | | 33.4 | 23.4 | 13.4 | 33.4 | 23.4 | 33.4 | 23.4 | 23.4 | 53.4 |
| Recycled | 90 g/10 min | 20 | 30 | 40 | — | — | — | — | — | — |
| pp (wt %) | 10 g/10 min | — | — | — | 20 | — | — | — | — | — |
| | | — | — | — | — | 30 | — | — | — | — |
| | 20 g/10 min | — | — | — | — | — | 20 | — | — | — |
| | | — | — | — | — | — | — | 30 | — | — |
| | 50 g/10 min | — | — | — | — | — | — | — | 30 | — |

| | | | | | | | | | |
|---|---|---|---|---|---|---|---|---|---|
| Glass fiber (wt %) | 40 | 40 | 40 | 40 | 40 | 40 | 40 | 40 | 40 |
| Compatibilizer (wt %) | 2.7 | 2.7 | 2.7 | 2.7 | 2.7 | 2.7 | 2.7 | 2.7 | 2.7 |
| Impact-resistant agent | 1.8 | 1.8 | 1.8 | 1.8 | 1.8 | 1.8 | 1.8 | 1.8 | 1.8 |
| (wt %) | | | | | | | | | |
| Heat-resistant agent | 0.9 | 0.9 | 0.9 | 0.9 | 0.9 | 0.9 | 0.9 | 0.9 | 0.9 |
| (wt %) | | | | | | | | | |
| Colorant (wt %) | 1.2 | 1.2 | 1.2 | 1.2 | 1.2 | 1.2 | 1.2 | 1.2 | 1.2 |
| Tensile strength (MPa) | 120 | 115 | 110 | 118 | 112 | 117 | 113 | 110 | 148 |
| Flexural strength (MPa) | 141 | 139 | 144 | 142 | 136 | 141 | 133 | 137 | 180 |
| Impact strength (kJ/m²) | 13.1 | 12.4 | 12.1 | 12.2 | 11.5 | 12.7 | 12.0 | 12.3 | 23.0 |
| Heat deflection | 155 | 155 | 153 | 154 | 154 | 153 | 151 | 154 | 160 |
| temperature (° C.) | | | | | | | | | |
| Fiber aggregation | 1.0 | 1.5 | 1.0 | 20.0 | 22.0 | 20.0 | 23.0 | 14.0 | 1.0 |
| number/350 cm² | | | | | | | | | |

pp: polypropylene

As may be seen from Table 1 and FIG. 1 above, in the case of Examples 1 to 3 in which a high-flowability recycled polypropylene resin having a melt-flow index of 90 g/min was added, the flowability was improved, so that no glass fiber aggregates appeared on the product surface during injection. On the other hand, as may be seen from Table 1 and FIG. 2 above, when a general low-flowability recycled polypropylene resin was added, such as in Comparative Examples 1 to 4, or a medium-flowability recycled polypropylene resin was added, such as in Comparative Example 5, the flowability did not match with the virgin polypropylene resin, so that the flowability was reduced, and a phenomenon of aggregating glass fibers on the exterior occurred during injection. As such, it was confirmed that the flowability between the virgin and recycled polypropylene resins could be matched, thereby satisfying both excellent mechanical properties and high recycled material content of the compounding composition.

Meanwhile, the mechanical properties of Examples were inferior overall to Comparative Example 6 using only the virgin polypropylene resin. Thus, in order to confirm whether the compounding composition of Example was usable in the manufacture of actual automotive engineering parts, a component evaluation was conducted. Specifically, a stack vent filter cover was manufactured using the compounding composition of Example 3, which had the lowest mechanical properties among Examples, and then test items listed in Table 2 below were evaluated.

TABLE 2

| Test item | | Test method |
|---|---|---|
| Vibration evaluation | | Carrying out test for 30 hours according |
| | | to vibration specifications set in X, Y, |
| | | and Z axes |
| Environment | Heat aging | Tested under conditions of 120° C., 96 |
| | | hours |
| | Thermal shock | Tested under conditions of −40 ↔ 120° |
| | resistance | C., 120 cycles |
| | Ozone aging | Tested under conditions of ozone |
| | | concentration: 50 pphm, 40° C., 70 hours |
| | Corrosion | Tested according to KS D 9502 |
| | durability | |
| | Continuous | Evaluated continuous environment |
| | environment | durability by performing heat aging, ozone |
| | 2) | aging, corrosion durability, and thermal |
| | | shock tests |

| | |
|---|---|
| Watertightness | Tested according to KS C IEC 60529 |
| Impact resistance | After cooling at −40° C. for 5 hours, 500 |
| | g, 12 mm diameter weight was dropped |
| | from a height of 30 cm |

As a result of evaluating the test items listed in Table 2, it was confirmed that cracks, severe deformation that made assembly impossible, or breakage did not occur in the stack vent filter cover, and thus physical properties that could be applied to actual automotive components, and the like were secured.

Thus, it may be seen that the compounding composition according to the present disclosure may reduce material costs by including the recycled resin, impart an eco-friendly image to a finished product when used, and replace polyamide materials with excellent mechanical properties.

Features, structures, effects, and the like described in the above-described examples are comprised in at least one example of the present disclosure, and are not necessarily limited to one example. Furthermore, the features, structures, effects, and the like illustrated in each example may be combined or modified even in other examples by those of ordinary skill in the art to which the examples pertain. Accordingly, the contents related to these combinations and modifications should be interpreted to cover the scope of the present disclosure.

1. A compounding composition comprising: a polypropylene resin comprising a virgin polypropylene resin having a melt-flow index of 60 g/10 min to 100 g/10 min and a recycled polypropylene resin having a melt-flow index of 80 g/10 min to 100 g/10 min, as measured under conditions of 230° C. and 2.16 kg load according to ASTM D1238; glass fiber; and an additive.

2. The compounding composition of claim 1, wherein the polypropylene resin comprises the virgin polypropylene resin and the recycled polypropylene resin in a weight ratio of 1:0.5 to 1:5.

3. The compounding composition of claim 1, wherein the virgin polypropylene resin comprises a homopolypropylene resin, an ethylene-propylene copolymer resin, or a combination thereof.

4. The compounding composition of claim 1, wherein the recycled polypropylene resin comprises a homopolypropylene resin, an ethylene-propylene copolymer resin, an ethylene-octene copolymer resin, or a combination thereof.

5. The compounding composition of claim 1, wherein the glass fiber has a cross-sectional diameter of 12 μm to 20 μm and an average length of 6 mm to 20 mm.

6. The compounding composition of claim 1, wherein the glass fiber is surface-modified by a silane coupling agent.

7. The compounding composition of claim 1, wherein the additive comprises at least one selected from the group consisting of a compatibilizer, an impact-resistant agent, a heat-resistant agent, a colorant, a release agent, and a nucleating agent.

8. The compounding composition of claim 1, wherein the compounding composition comprises 50 wt % to 60 wt % of the polypropylene resin, 20 wt % to 50 wt % of the glass fiber, and 5 wt % to 20 wt % of the additive, based on the total weight of the compounding composition.

9. The compounding composition of claim 1, wherein the compounding composition has an Izod impact strength of 10 kJ/m² to 50 kJ/m² as measured according to ISO 180.

10. The compounding composition of claim 1, wherein the compounding composition has a heat deflection temperature of 150° C. to 200° C. as measured according to ISO 75.

11. An injection-molded product formed from the compounding composition according to claim 1.
